(19) United States
(12) Patent Application Publication
(10) Pub. No.: US 2026/0149967 A1
(43) Pub. Date: May 28, 2026

(54) COMMUNICATION APPARATUS, COMMUNICATION TERMINAL, AND COMMUNICATION METHOD

(71) Applicant: Sony Group Corporation, Tokyo (JP)

(72) Inventor: Kosuke AIO, Tokyo (JP)

(73) Assignee: Sony Group Corporation, Tokyo (JP)

(21) Appl. No.: 18/867,025

(22) PCT Filed: May 11, 2023
(86) PCT No.: PCT/JP2023/017665

§ 371 Date: Jul. 23, 2025

(30) Foreign Application Priority Data
May 27, 2022 (JP) 2022-086794

(51) Int. Cl. H04W 12/0431; H04W 12/041

(52) U.S. Cl. CPC H04W 12/0431; H04W 12/041

(57) ABSTRACT

The present technology relates to a communication apparatus, a communication terminal, and a communication method capable of facilitating management of a secret key for performing coordinated transmission.

The communication apparatus shares a first secret key for coordinated transmission and groupcast, which is used when the coordinated transmission is performed on a communication terminal together with one or a plurality of other communication apparatuses, with the other communication apparatuses. The present technology can be applied to a wireless communication system.

### DESCRIPTION

### Technical Field

The present technology relates to a communication apparatus, a communication terminal, and a communication method, and more particularly, to a communication apparatus, a communication terminal, and a communication method capable of facilitating management of a secret key for performing coordinated transmission.

### Background Art

In recent years, an environment in which access points (hereinafter referred to as AP) of a plurality of wireless local area networks (LANs) are installed in a stadium or a home has increased, and a technology aiming at improving throughput and reliability of a system by coordination between APs has attracted attention.

For example, Joint Transmission (Joint Tx or JTX), which is one of coordination schemes, is a technique of performing coordinated transmission to a wireless terminal (station, hereinafter referred to as STA) common to a plurality of APs using a Multi Input Multi Output (MIMO) technique. By performing the Joint Tx, it is possible to form a highly dimensional beam without increasing the number of antennas provided in one AP.

In the Joint Tx, the same MAC processing needs to be performed on the same packet addressed to a certain STA.

Therefore, at least the APs performing the Joint Tx must hold the same secret key.

For example, Patent Document 1 discloses a method of sharing a secret key (Pairwise Transient Key, hereinafter PTK) for Pear-to-Pear (P2P) generated between certain APs and STAs with other APs via a wire.

### CITATION LIST

### Patent Document

Patent Document 1: Japanese Patent Application Laid-Open No. 2016-128869

### SUMMARY OF THE INVENTION

### Problems to be Solved by the Invention

However, in a case where the Joint Tx is performed, STAs that are candidates exist in a plurality of cells (Basic Service Set, hereinafter BSS), and thus the number of STAs becomes enormous and it becomes difficult to manage the secret key. Furthermore, in an environment where APs are wirelessly connected to each other, an action of sharing PTKs wirelessly has a high risk of information leakage.

The present technology has been made in view of such a situation, and makes it possible to facilitate management of a secret key for performing coordinated transmission.

### Solutions to Problems

A communication apparatus according to one aspect of the present technology includes a communication control unit that shares a first secret key for coordinated transmission and groupcast, which is used when the coordinated transmission is performed on a communication terminal together with one or a plurality of other communication apparatuses, with the other communication apparatuses.

A communication terminal according to another aspect of the present technology includes a communication control unit that sets a first secret key to be used for decryption on the basis of identification information indicating a communication apparatus that performs coordinated transmission together using the first secret key for the coordinated transmission and groupcast when a signal is received by the coordinated transmission by a plurality of communication apparatuses.

In one aspect of the present technology, a first secret key for coordinated transmission and groupcast, which is used when the coordinated transmission is performed on a communication terminal together with one or a plurality of other communication apparatuses is shared with the other communication apparatuses.

In another aspect of the present technology, a first secret key to be used for decryption is set on the basis of identification information indicating a communication apparatus that performs coordinated transmission together using the first secret key for the coordinated transmission and groupcast when a signal is received by the coordinated transmission by a plurality of communication apparatuses.

### BRIEF DESCRIPTION OF DRAWINGS

FIG. 1 is a diagram illustrating a configuration example of a wireless communication system according to a first embodiment of the present technology.

FIG. 2 is a block diagram illustrating a configuration example of a communication apparatus operating as an AP.

FIG. 3 is a block diagram illustrating a configuration example of a communication apparatus operating as an STA.

FIG. 4 is a diagram illustrating an overall sequence according to the first embodiment of the present technology.

FIG. 5 is a diagram illustrating a first sequence for AP1 and AP2 to share the same JGTK in the Joint Tx Setup Phase.

FIG. 6 is a diagram illustrating a configuration example of a JGTK Handshake msg#1 frame.

FIG. 7 is a diagram illustrating a configuration example of a JGTK Handshake msg#2 frame.

FIG. 8 is a diagram illustrating a second sequence for AP1 and AP2 to share the same JGTK in the Joint Tx Setup Phase.

FIG. 9 is a diagram illustrating a configuration example of a JGTK Sharing frame.

FIG. 10 is a flowchart for explaining processing of AP1 that starts JGTK sharing.

FIG. 11 is a flowchart for explaining processing of AP2.

FIG. 12 is a diagram illustrating a sequence in Link Setup Phase.

FIG. 13 is a diagram illustrating a configuration example of a 4-way Handshake msg#3 frame.

FIG. 14 is a flowchart for explaining processing of an STA.

FIG. 15 is a diagram illustrating a configuration example of a wireless communication system according to a second embodiment of the present technology.

FIG. 16 is a diagram illustrating a third sequence for AP211, AP1, and AP2 to share the same JGTK in the Joint Tx Setup Phase.

FIG. 17 is a diagram illustrating a fourth sequence for AP1 and AP2 to share the same JGTK in the Joint Tx Setup Phase.

FIG. 18 is a diagram illustrating a configuration example of a JGTK Info Request frame.

FIG. 19 is a diagram illustrating a configuration example of a JGTK Info Response frame.

FIG. 20 is a diagram illustrating a fifth sequence for AP1 and AP2 to share the same JGTK in the Joint Tx Setup Phase.

FIG. 21 is a diagram illustrating a configuration example of a JGTK Generation Request frame.

FIG. 22 is a diagram illustrating a configuration example of a JGTK Generation Response frame.

FIG. 23 is a flowchart for explaining processing of a control AP.

FIG. 24 is a flowchart for explaining processing of a non-control AP.

FIG. 25 is a block diagram illustrating a configuration example of a computer.

### MODE FOR CARRYING OUT THE INVENTION

Hereinafter, modes for carrying out the present technology will be described. The description will be given in the following order.
1. First Embodiment
2. Second Embodiment
3. Others

### 1. First Embodiment

### System Configuration

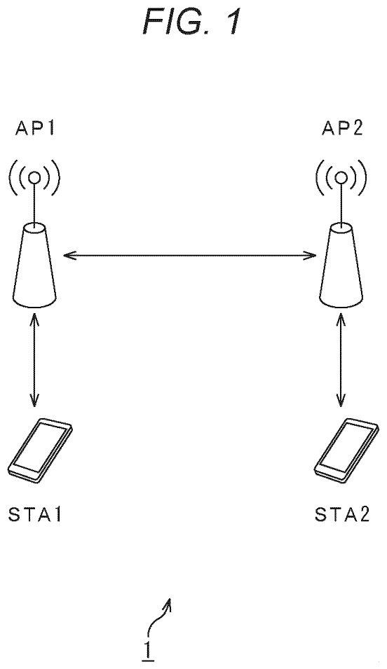

FIG. 1 is a diagram illustrating a configuration example of a wireless communication system according to a first embodiment of the present technology.

The wireless communication system 1 of FIG. 1 includes two of AP1 and AP2 and two of STA1 and STA2. Note that AP1 and AP2 are referred to as APs in a case where it is not particularly necessary to distinguish them, and STA1 and STA2 are referred to as STAs in a case where it is not particularly necessary to distinguish them.

STA1 is connected to AP1 by wireless communication. STA2 is connected to AP2 by wireless communication.

In addition, there is a communication apparatus that uses a channel in the same band as the band used by AP1, AP2, STA1, and STA2 around the communication apparatus.

Note that, in FIG. 1, the link between AP1 and AP2 is referred to as a backhaul link, and the link between AP1 and STA1 and the link between AP2 and STA2 is referred to as a fronthaul link. A communication form of the backhaul link is not particularly limited.

In addition, the target system configuration is not limited to this, and it is sufficient that there is a plurality of communication apparatuses to which connection is established and there are communication apparatuses around each communication apparatus, and the positional relationship is not limited as long as the above-described conditions are satisfied.

### Configuration of Communication Apparatus

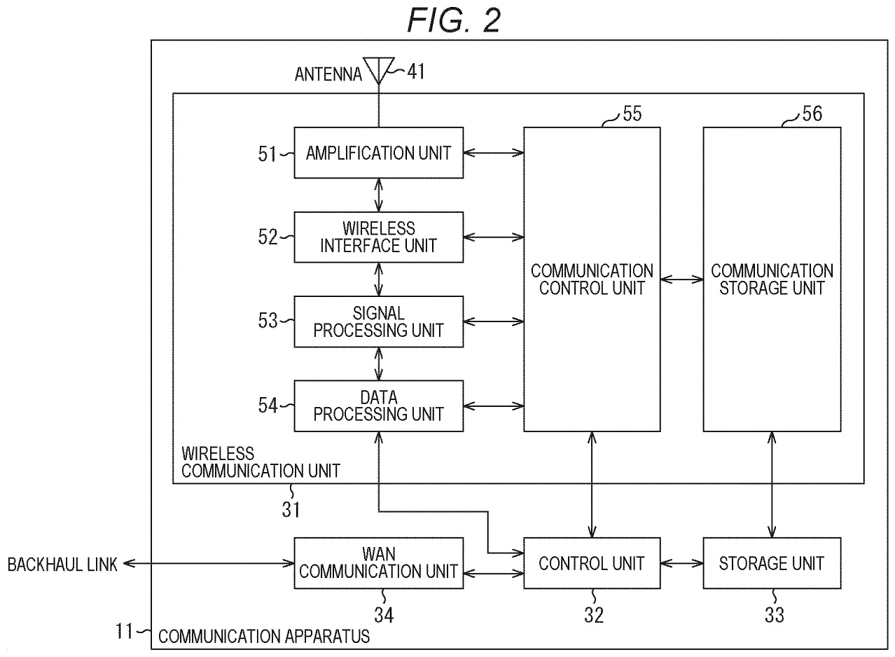

FIG. 2 is a block diagram illustrating a configuration example of a communication apparatus operating as an AP.

The communication apparatus 11 includes a wireless communication unit 31, a control unit 32, a storage unit 33, a wide area network (WAN) communication unit 34, and an antenna 41.

The wireless communication unit 31 transmits and receives data. The wireless communication unit 31 includes an amplification unit 51, a wireless interface unit 52, a signal processing unit 53, a data processing unit 54, a communication control unit 55, and a communication storage unit 56.

The wireless communication unit 31 includes only one set of the amplification unit 51, the wireless interface unit 52, the signal processing unit 53, and the data processing unit 54 as a minimum configuration, but may include a plurality of antennas 41 and the amplification unit 51 to enable MIMO transmission and reception processing. Furthermore, the wireless communication unit 31 may have a configuration capable of operating a plurality of links or a plurality of frequency channels in parallel.

At the time of transmission, the amplification unit 51 amplifies the analog signal supplied from the wireless interface unit 52 to predetermined power, and outputs the analog signal obtained by amplifying the power to the antenna 41. At the time of reception, the amplification unit 51 amplifies the analog signal supplied from the antenna 41 to predetermined power, and outputs the analog signal obtained by amplifying the power to the wireless interface unit 52.

A part of the function of the amplification unit 51 may be included in the wireless interface unit 52. In addition, a part of the function of the amplification unit 51 may be a component outside the wireless communication unit 31.

At the time of transmission, the wireless interface unit 52 converts the transmission symbol stream from the signal processing unit 53 into an analog signal, performs filtering, up-conversion to a carrier frequency, and phase control, and outputs the analog signal after the phase control to the amplification unit 51.

At the time of reception, the wireless interface unit 52 performs phase control, down-conversion, and inverse filtering on the analog signal supplied from the amplification unit 51, and outputs a reception symbol stream that is a result of conversion into a digital signal to the signal processing unit 53.

At the time of transmission, the signal processing unit 53 performs encoding, interleaving, modulation, and the like on the data unit supplied from the data processing unit 54, assigns a physical header, and outputs a transmission symbol stream to each wireless interface unit 52.

At the time of reception, the signal processing unit 53 analyzes the physical header of the reception symbol stream supplied from each wireless interface unit 52, performs demodulation, deinterleaving, decoding, and the like on the reception symbol stream, and generates a data unit. The generated data unit is output to the data processing unit 54.

Note that the signal processing unit 53 performs complex channel characteristic estimation and spatial separation processing as necessary.

At the time of transmission, the data processing unit 54 performs sequence management and encryption processing of the data held in the communication storage unit 56 and the control signal and the management information received from the communication control unit 55. After the encryption processing, the data processing unit 54 assigns a media access control (MAC) header and an error detection code, generates a packet, and performs multiple aggregation processing on the packet.

At the time of reception, the data processing unit 54 performs deaggregation processing of the received packet, analysis and error detection of the MAC header, a retransmission request operation, and reorder processing.

The communication control unit 55 controls operation of each unit of the wireless communication unit 31 and information transmission between the units. Furthermore, the communication control unit 55 performs control to deliver a control signal and management information of which notification is provided to another communication apparatus to the data processing unit 54.

The communication storage unit 56 holds information used by the communication control unit 55. Furthermore, the communication storage unit 56 holds a packet to be transmitted and a received packet. A transmission buffer that holds packets to be transmitted is included in the communication storage unit 56.

There may be a plurality of wireless communication units 31. For example, communication between AP and AP and communication between AP and STA may be performed using different wireless communication units 31.

In addition, a plurality of the same blocks may exist in one wireless communication unit 31. For example, the wireless communication unit 31 may include a plurality of wireless interface units 52, amplification units 51, and antennas 41 for MIMO communication. Furthermore, in order to support Multi-Link communication, in the wireless communication unit 31, the data processing unit 54 may be divided in the middle, and there may be a plurality of subsequent processing units (a part of the data processing unit 54, the signal processing unit 53, the wireless interface unit 52, and the amplification unit 51).

The control unit 32 includes a central processing unit (CPU), a read only memory (ROM), a random access memory (RAM), and the like. The control unit 32 executes a program stored in the ROM or the like, and controls the wireless communication unit 31 and the communication control unit 55. Furthermore, the control unit 32 may perform some operation of the communication control unit 55 instead. Furthermore, the communication control unit 55 and the control unit 32 may be configured as one block.

The storage unit 33 holds information used by the wireless communication unit 31 and the control unit 32. Furthermore, the storage unit 33 may perform a part of the operation of the communication storage unit 56 instead. The storage unit 33 and the communication storage unit 56 may be configured as one block.

The WAN communication unit 34 analyzes the packet acquired from the backhaul link, and delivers the analyzed packet to the wireless communication unit 31 via the control unit 32. The format of the delivered packet may be a state in which the IP Header is left as it is (access point mode) or a state in which the IP Header is analyzed and removed by the WAN communication unit 34 (router mode).

Note that FIG. 2 illustrates an example in which the wireless communication unit 31 is configured as one IC, but the IC configuration of the present technology is not limited thereto. For example, the wireless interface unit 52 may be mounted as an IC different from the IC of the wireless communication unit 31.

### Configuration of Communication Apparatus

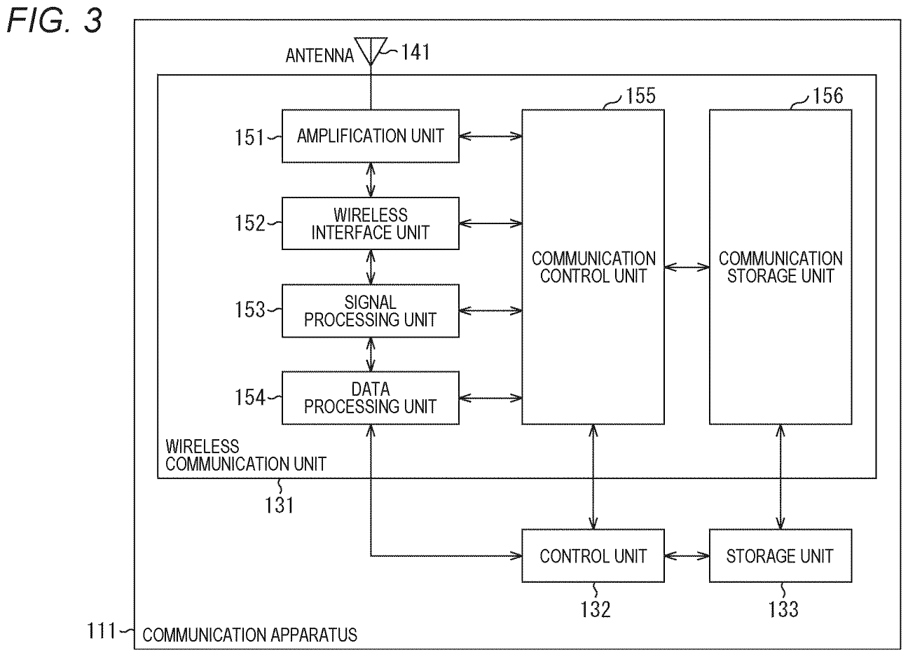

FIG. 3 is a block diagram illustrating a configuration example of a communication apparatus operating as an STA.

The communication apparatus 111 includes a wireless communication unit 131, a control unit 132, a storage unit 133, and an antenna 141.

The control unit 132, the storage unit 133, and the antenna 141 in FIG. 3 have configurations similar to the control unit 32, the storage unit 33, and the antenna 41 in FIG. 2.

The wireless communication unit 131 includes an amplification unit 151, a wireless interface unit 152, a signal processing unit 153, a data processing unit 154, a communication control unit 155, and a communication storage unit 156.

The amplification unit 151, the wireless interface unit 152, the signal processing unit 153, the data processing unit 154, the communication control unit 155, and the communication storage unit 156 in FIG. 3 have configurations similar to the amplification unit 51, the wireless interface unit 52, the signal processing unit 53, the data processing unit 54, the communication control unit 55, and the communication storage unit 56 in FIG. 2.

Note that the wireless communication unit 131 includes only one set of the amplification unit 151, the wireless interface unit 152, the signal processing unit 153, and the data processing unit 154 as a minimum configuration, but may include a plurality of antennas 141 and the amplification unit 151 to enable MIMO transmission and reception processing. Furthermore, the wireless communication unit 131 may have a configuration capable of operating a plurality of links or a plurality of frequency channels in parallel.

### Overall Sequence

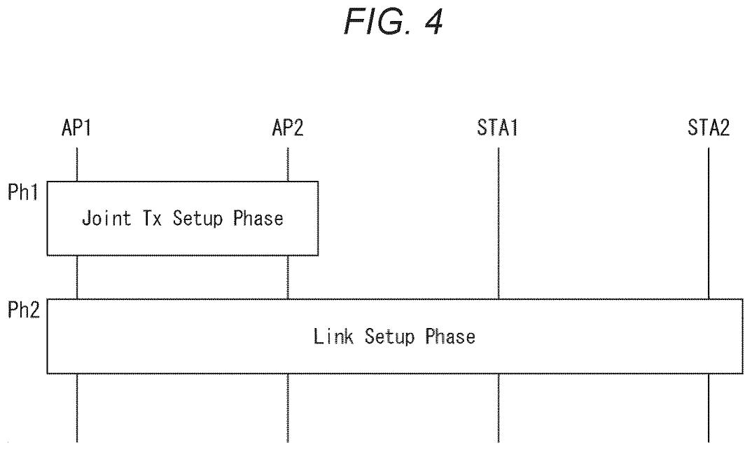

FIG. 4 is a diagram illustrating an overall sequence according to the first embodiment of the present technology.

In FIG. 4, the overall sequence includes Joint Tx Setup Phase of Ph1 and Link Setup Phase of Ph2.

In the Joint Tx Setup Phase of Ph1, AP1 and AP2 perform setup for cooperative communication between AP1 and AP2.

Specifically, in the Joint Tx Setup Phase, AP1 and AP2 exchange Capability information with each other, and establish a link and a group for cooperative communication. In the present technology, in the Joint Tx Setup Phase, a groupcast secret key (Joint Tx Group Temporary Key, hereinafter referred to as JGTK) dedicated to Joint Tx, which is used only at the time of Joint Tx, is shared between AP1 and AP2.

In the Link Setup Phase of Ph2, AP1, AP2, STA1, and STA2 perform link setup between AP1 and STA1 and between AP2 and STA2.

Specifically, AP1, AP2, STA1, and STA2 perform connection processing between AP1 and STA1 and between AP2 and STA2, respectively, and then generate a groupcast secret key (Group Temporary Key, hereinafter referred to as GTK) by 4-way Handshake. Note that the GTK is not dedicated to coordinated transmission, and thus is a key different from the JGTK dedicated to coordinated transmission. Furthermore, in the present technology, the STA is notified of the above-described JGTK in the 4-way Handshake.

Note that this notification of JGTK may be performed after the connection processing between the AP and the STA and the secret key (GTK) generation processing have already been completed. That is, for example, after connection processing with the AP and the STA and secret key (GTK) generation processing are completed, the above-described Joint Tx Setup Phase may be performed, and notification of the JGTK to the STA may be performed again when the JGTK is generated for the first time or when the existing JGTK is updated.

### First Sequence in Joint Tx Setup Phase

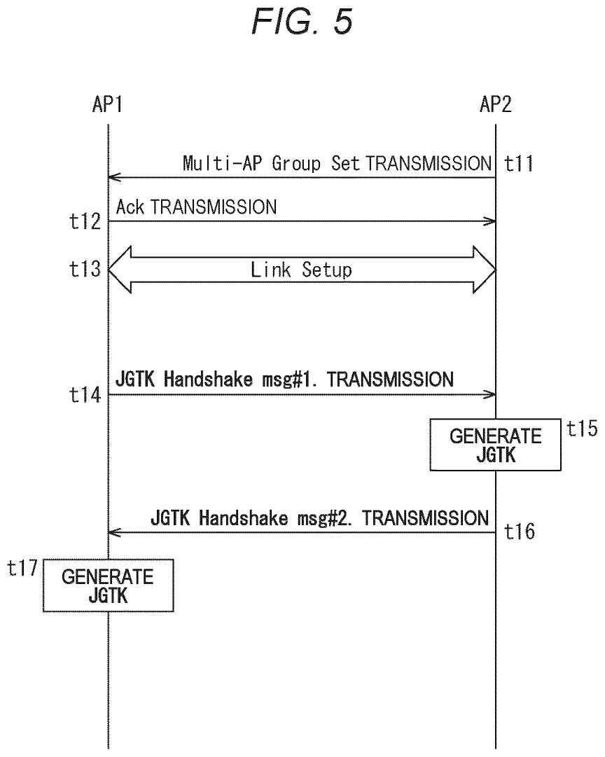

FIG. 5 is a diagram illustrating a first sequence for AP1 and AP2 to share the same JGTK in the Joint Tx Setup Phase of FIG. 4.

FIG. 5 illustrates a sequence in which the same JGTK is generated by AP1 and AP2 performing information exchange (Handshake) as the first sequence.

One of AP1 and AP2 (AP2 in the case of FIG. 5) transmits a Multi-AP Group Set frame at timing t11, and sets a group for performing cooperative communication. Note that, in the following drawings including FIG. 5, the characters of frame are omitted in the frame name to be transmitted for convenience of description.

AP1 receives the Multi-AP Group Set frame, and transmits an Ack indicating a response confirmation at timing t12.

The Multi-AP Group Set frame includes its own Capability information, information for generating an encryption key (Robust Security Network Element, hereinafter RSNE), and the like. By transmitting and receiving the Multi-AP Group Set frame and Ack (hereinafter, referred to as Multi-AP Group Set), a coordination scheme (in the present embodiment, Joint Tx) and an encryption scheme performed between APs are determined.

AP1 and AP2 perform Link Set Up between AP1 and AP2 at timing t13. The link setup mainly establishes a method for exchanging control signals between AP1 and AP2.

Note that, in the link setup, for example, two APs may perform link setting using the relationship between the AP and the STA, or both may establish P2P communication as the STA. In addition, the secret key between the links may or may not be set.

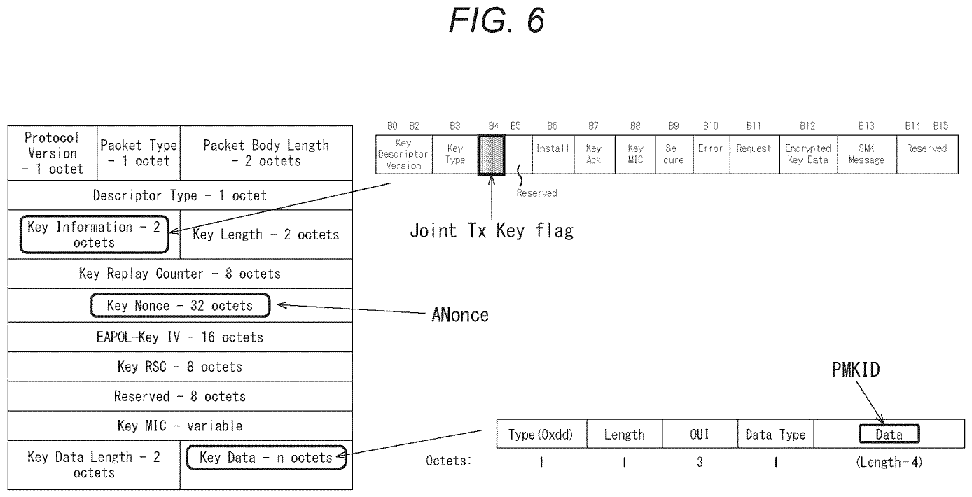

At timing t14, either AP1 or AP2 (AP1 in the case of FIG. 5) transmits a JGTK Handshake msg#1 frame. Details of the JGTK Handshake msg#1 frame will be described later with reference to FIG. 6.

By transmitting the JGTK Handshake msg#1 frame, it is notified that the JGTK is to be generated between AP1 and AP2, and at the same time, public key (Pairwise Master Key, hereinafter referred to as PMK) information and random number information (ANonce) which are information necessary for JGTK generation are notified.

The other AP (AP2 in the case of FIG. 5) receives the JGTK Handshake msg#1 frame transmitted from AP1. At timing t15, AP2 generates the JGTK on the basis of the information acquired by receiving the JGTK Handshake msg#1 frame and the random number information (SNonce) generated by itself.

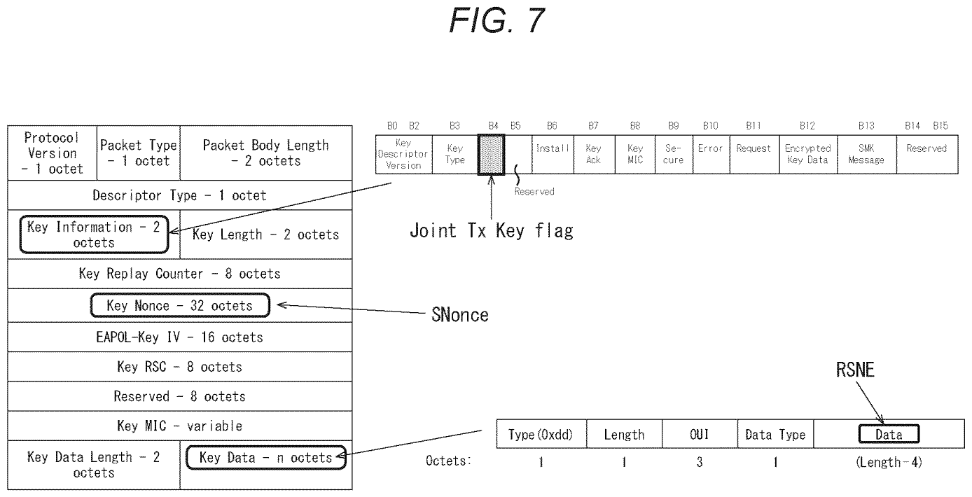

At timing t16, AP2 transmits a JGTK Handshake msg#2 frame to AP1. The GTK Handshake msg#2 frame includes random number information (SNonce) and RSNE that is information for generating an encryption key of the responder. Details of the JGTK Handshake msg#2 frame will be described later with reference to FIG. 7.

AP1 receives the JGTK Handshake msg#2 frame transmitted from AP2. Thereafter, at timing t17, the JGTK is generated on the basis of the information acquired from AP2 and the random number information (ANonce) generated by itself by receiving the JGTK Handshake msg#2 frame. Thereafter, the first sequence ends.

As described above, the JGTK is shared by AP1 and AP2. In the first sequence, it is not necessary for both AP1 and AP2 to communicate the JGTK itself, and thus there is no concern that the JGTK leaks as it is to another person when the radio wave is intercepted.

However, in a case where there are three or more APs that perform cooperative communication or the like, it is difficult to take a process of generating the same JGTK as more than two APs in the first sequence.

Meanwhile, since the JGTK can be provided for each combination of APs that perform cooperative communication, the JGTK can be selectively used according to a combination of APs that perform cooperative communication, such as a combination of AP1 and AP2 and a combination of AP1 and APx.

### Configuration of JGTK Handshake msg#1 Frame

FIG. 6 is a diagram illustrating a configuration example of a JGTK Handshake msg#1 frame.

The JGTK Handshake msg#1 frame includes Protocol Version, Packet Type, Packet Body length, Descriptor Type, Key Information, Key Length, Key Replay Counter, Key Nonce, EAPOL Key IV, Key RSC, Reserved, Key MIC, Key Data length, Key Data, and the like.

The Key Information includes each bit of Key Discripter version, Key type, Reserved, install, Key Ack, Key MIC, Secure, Error, Request, Encripted key Data, SMK Message, Joint Tx Key flag, Reserved, and the like, as illustrated in the upper right.

A Joint Tx Key flag is assigned to one bit of Key Information. The Joint Tx Key flag is flag information indicating that the JGTK Handshake msg#1 frame relates to the JGTK.

Information in the Key Nonce indicates the ANonce. The ANonce is random number information generated by the requester side necessary for JGTK generation.

The Key Data includes each field of Type, Length, OUI, Data Type, and Data in one or a plurality of KDE formats.

One or a plurality of KDE format Data fields included in the Key Data includes PKMID information. As described above, the PKMID information is information indicating a public key necessary for JGTK generation. In addition, a notification indicating that the PKMID information is included in the Key Data is given in the Type field.

Note that, in FIG. 6, the JGTK Handshake msg#1 frame is described on the basis of the EAPOL-key frame of IEEE802.11, but is not limited to the frame configuration of FIG. 6, and at least the information described above is only required to be included in the frame. Furthermore, although the JGTK Handshake msg#1 frame in FIG. 6 is described on the assumption of being transmitted as a MAC Frame, the JGTK Handshake msg#1 frame may be transmitted as a TCP/IP Frame as long as the above-described information is described.

### Configuration of JGTK Handshake msg#2 Frame

FIG. 7 is a diagram illustrating a configuration example of JGTK Handshake msg#2 frame.

Note that, in FIG. 7, since the JGTK Handshake msg#2 frame has a frame configuration basically similar to that of the JGTK Handshake msg#1 frame in FIG. 6, only portions different from those of the JGTK Handshake msg#1 frame in FIG. 6 will be described.

A Joint Tx Key flag is assigned to one bit of Key Information. The Joint Tx Key flag is flag information indicating that the JGTK Handshake msg#2 frame relates to the JGTK.

Information in the Key Nonce indicates the SNonce. The SNonce is random number information generated by the responder side necessary for JGTK generation.

The RSNE is included in a Data field of one or a plurality of KDE formats included in the Key Data. As described above, the RSNE is information for generating an encryption key of the responder. Note that a notification indicating that the RSNE is included in the Key Data is given in the Type field.

### Second Sequence in Joint Tx Setup Phase

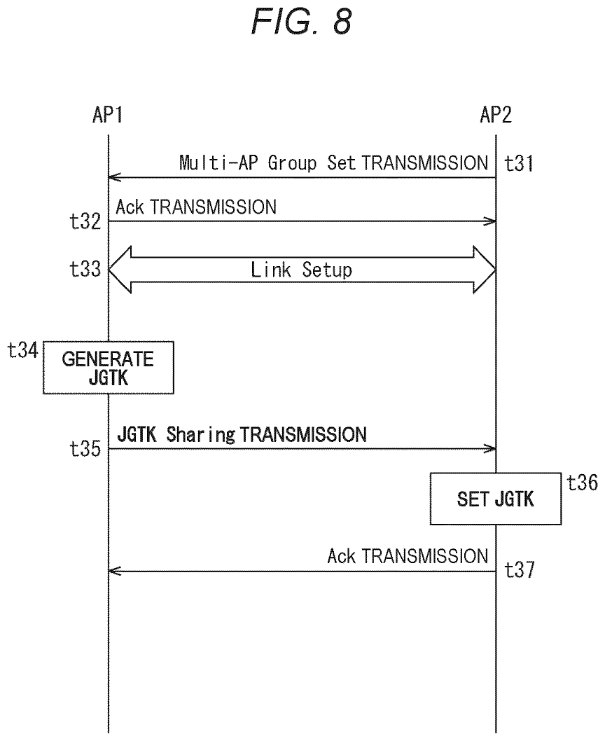

FIG. 8 is a diagram illustrating a second sequence for AP1 and AP2 to share the same JGTK in the Joint Tx Setup Phase of FIG. 4.

FIG. 8 illustrates a sequence of distributing the JGTK generated by AP1 to AP2 as the second sequence.

Since the processing at the timings t31 to t33 in FIG. 8 is similar to the processing at the timings t11 to t13 in FIG. 5, the description thereof will be omitted.

At timing t34, either AP1 or AP2 (AP1 in the case of FIG. 8) generates the JGTK only with its own held parameters.

At timing t35, AP1 transmits a JGTK Sharing frame including the generated JGTK to the other AP (AP2 in the case of FIG. 8).

AP2 receives the JGTK Sharing frame transmitted from AP1. Thereafter, at timing t36, AP2 sets the received JGTK as a key used at the time of Joint Tx.

At timing t37, AP2 transmits Ack as a receipt acknowledgment to AP1. AP1 receives the Ack transmitted from AP1. Thereafter, the second sequence ends.

As described above, the JGTK is shared by AP1 and AP2. In the second sequence, since any one of the APs generates and distributes the JGTK, the second sequence can be applied even in a case where there are three or more APs that perform coordinated transmission.

Meanwhile, since it is necessary to wirelessly communicate the JGTK as it is, there is a risk that the secret key is leaked as it is when the radio wave is intercepted.

In a case where the encryption scheme is set in the link between the APs, the risk is reduced, but in a case where security concerns are emphasized, the first sequence in FIG. 4 is more suitable although inefficient.

Whether the first or second sequence described above is to be used may be selected by the AP in view of the surrounding environment situation according to the combination of APs, or the setting fixed in either mode at the time of product shipment may be changed by the user. In addition, whether the first or second sequence is to be used may be specifically set according to the use application in the standard.

### Configuration of JGTK Sharing Frame

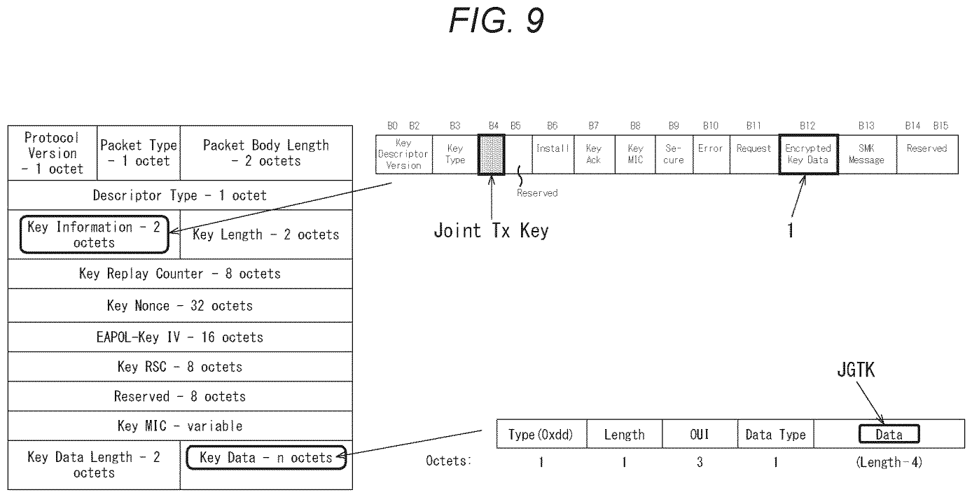

FIG. 9 is a diagram illustrating a configuration example of a JGTK Sharing frame.

Note that, in FIG. 9, since the JGTK Sharing frame has a frame configuration basically similar to that of the JGTK Handshake msg#1 frame in FIG. 6, only portions different from those of the JGTK Handshake msg#1 frame in FIG. 6 will be described.

A Joint Tx Key flag is assigned to one bit of Key Information. The Joint Tx Key flag is flag information indicating that the JGTK Sharing frame relates to the JGTK.

The Encrypted Key Data of the Key Information is information indicating that the subsequent Key Data is encrypted, and 1 is described in the case of FIG. 9.

The JGTK information is included in a Data field of one or a plurality of KDE formats included in the Key Data. The JGTK information is information indicating a shared JGTK. Note that a notification indicating that the JGTK information is included in the Key Data is given in the Type field.

### Processing of AP1

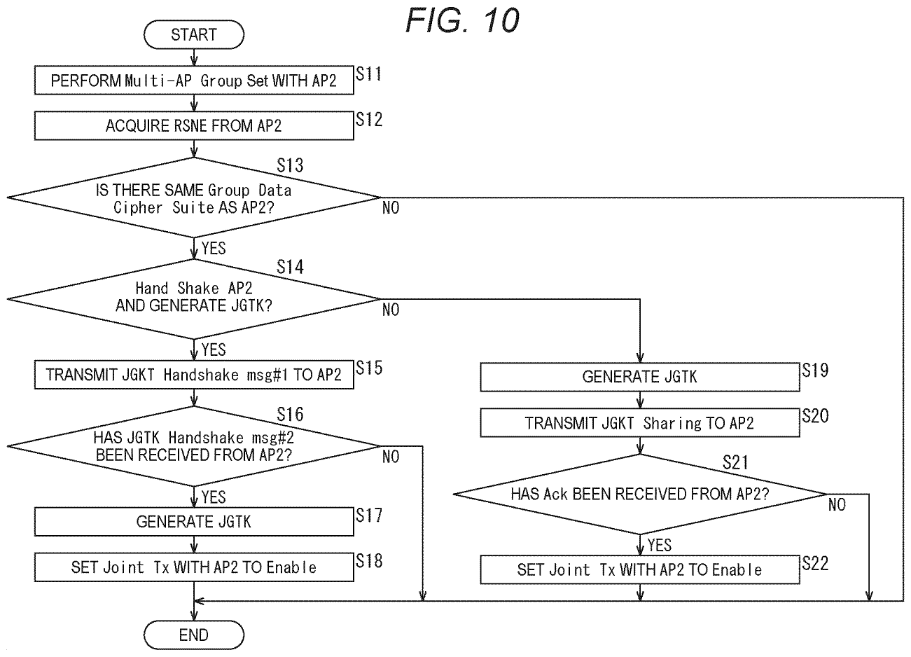

FIG. 10 is a flowchart for explaining processing of the AP (AP1 in the case of FIG. 10) that starts JGTK sharing.

Note that the processing of FIG. 10 is processing performed by the communication control unit 55 of AP1 controlling each unit of the wireless communication unit 31.

In step S11, the communication control unit 55 of AP1 performs Multi-AP Group Set with AP2 (for example, timings t1 and t2 in FIG. 5). At this time, the communication control unit 55 receives the Multi-AP Group Set flame transmitted from AP2, and transmits an Ack corresponding to the received Multi-AP Group Set flame to AP2.

In step S12, the communication control unit 55 acquires the RSNE which is information for generating the encryption key of AP2 from the received Multi-AP Group Set flame.

In step S13, the communication control unit 55 determines whether or not there is the same Group Data Cipher Suite between AP1 and AP2. Group Data Cipher Suite is a scheme of a groupcast encryption key.

In a case where AP1 does not have the same scheme as the Group Data Chipper Suite supported by AP2, it is determined in step S13 that there is no same Group Data Cipher Suite, and the process of FIG. 10 ends. Note that, at this time, AP2 may be notified that AP1 and AP2 cannot perform the Joint Tx.

In a case where there is at least one Group Data Chipper Suite that can be used in common with AP2, it is determined in step S13 that there is the same Group Data Cipher Suite, and the process proceeds to step S14.

In step S14, the communication control unit 55 determines whether to handshake the JGTK with AP2 and generate the JGTK together (first sequence) or generate and notify the JGTK by itself (second sequence). As described above, this determination may be made by the communication control unit 55 of AP1 by looking at the surrounding environment situation, may be made by allowing the user to change the setting fixed in one of the modes at the time of product shipment, or may be specifically set which is used according to the use application in the standard.

Furthermore, if the communication control unit 55 of AP1 makes a determination by looking at the surrounding situation, for example, the following determination criterion is provided.
(1) In a case where security is not established between the links of AP1 and AP2, it is determined that both generate the JGTK by performing Handshake
(2) When there are only two APs that can be used in Joint Tx at the same time, it is determined that both generate the JGTK by performing Handshake
(3) When the encryption is established between the links of AP1 and AP2 and the number of APs that can be used in the Joint Tx is three or more at the same time, it is determined that AP1 generates the JGTK and distributes the JGTK to other APs

Note that the “number of APs that can be used in the Joint Tx at the same time” described above is determined on the basis of any one of an upper limit value set in the standard, the number of APs belonging to a Multi-AP Group, and capabilities between APs.

In step S14, in a case where it is determined to handshake the JGTK with AP2 and generate the JGTK together, the process proceeds to step S15.

In step S15, the communication control unit 55 transmits a JGTK Handshake msg#1 frame to AP2 (for example, timing t14 in FIG. 5) .

Upon receiving the JGTK Handshake msg#1 frame, AP2 generates the JGTK and transmits the JGTK Handshake msg#2 frame (for example, timing t16 in FIG. 5).

In step S16, the communication control unit 55 determines whether or not the JGTK Handshake msg#2 frame transmitted from AP2 has been received. In a case where it is determined in step S16 that the JGTK Handshake msg#2 frame transmitted from AP2 has not been received, the process of FIG. 10 ends.

In a case where it is determined in step S16 that the JGTK Handshake msg#2 frame transmitted from AP2 is received, the process proceeds to step S17.

In step S17, the communication control unit 55 generates the JGTK. At this time, the SNonce and the RSNE information included in the JGTK Handshake msg#2 frame are used.

In step S18, the communication control unit 55 sets the Joint Tx with AP2 to “Enable” as the internal processing. Thereafter, the process of FIG. 10 ends.

In a case where it is determined in step S14 that the JGTK with AP2 is generated and notified, the process proceeds to step S19.

In step S19, the communication control unit 55 generates the JGTK (for example, timing t34 in FIG. 8).

In step S20, the communication control unit 55 transmits a JGTK Sharing frame including the generated JGTK to AP2 (for example, timing t35 in FIG. 8).

Upon receiving the JGTK Sharing frame, AP2 sets the JGTK as a key to be used at the time of Joint Tx, and transmits Ack.

In step S21, the communication control unit 55 determines whether or not Ack has been received from AP2. In a case where it is determined in step S21 that the Ack has been received from AP2, the process proceeds to step S22.

In step S22, the communication control unit 55 sets the Joint Tx with AP2 to “Enable” as the internal processing. Thereafter, the process of FIG. 10 ends.

Furthermore, in a case where it is determined in step S21 that the Ack has not been received from AP2, the process of FIG. 10 ends.

Note that, whether the JGTK is generated by both or only one, the process may be interrupted if there is no response from AP2 for a certain period of time.

### Processing of AP2

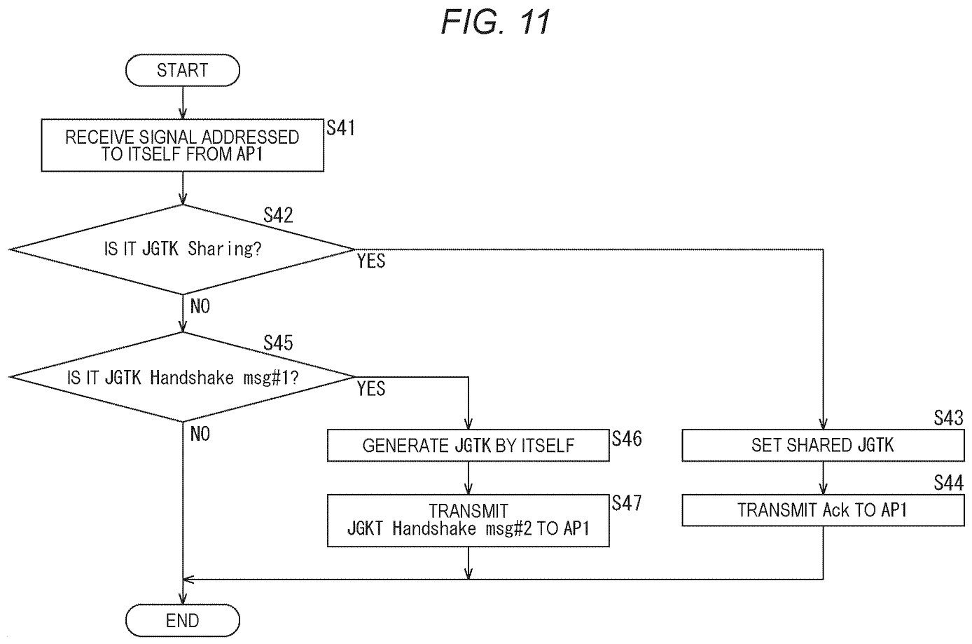

FIG. 11 is a flowchart for explaining processing of AP2.

Note that the processing of FIG. 11 is processing performed by the communication control unit 55 of AP2 controlling each unit of the wireless communication unit 31.

In step S41, the communication control unit 55 receives a signal addressed to itself from AP1.

In step S42, the communication control unit 55 determines whether or not the received signal is a JGTK Sharing frame.

In a case where it is determined in step S42 that the received signal is the JGTK Sharing frame, the process proceeds to step S43.

In step S43, the communication control unit 55 sets the shared JGTK as a key used at the time of Joint Tx on the basis of the JGTK Sharing frame (for example, timing t36 in FIG. 8).

In step S44, the communication control unit 55 transmits Ack to AP1. Thereafter, the process of FIG. 11 ends.

Meanwhile, in a case where it is determined in step S42 that the signal is not a JGTK Sharing frame, the process proceeds to step S45.

The communication control unit 55 determines whether or not the received signal is a JGTK Handshake msg#1 frame. In a case where it is determined in step S45 that the signal is a JGTK Handshake msg#1 frame, the process proceeds to step S46.

In step S46, the communication control unit 55 generates the JGTK by itself on the basis of the information included in the JGTK Handshake msg#1 frame (for example, timing t15 in FIG. 5).

In step S47, the communication control unit 55 transmits a JGTK Handshake msg#2 frame to AP1. Thereafter, the process of FIG. 11 ends.

Also in a case where it is determined in step S45 that the signal is not a JGTK Handshake msg#1 frame, the process of FIG. 11 ends.

### Sequence in Link Setup Phase

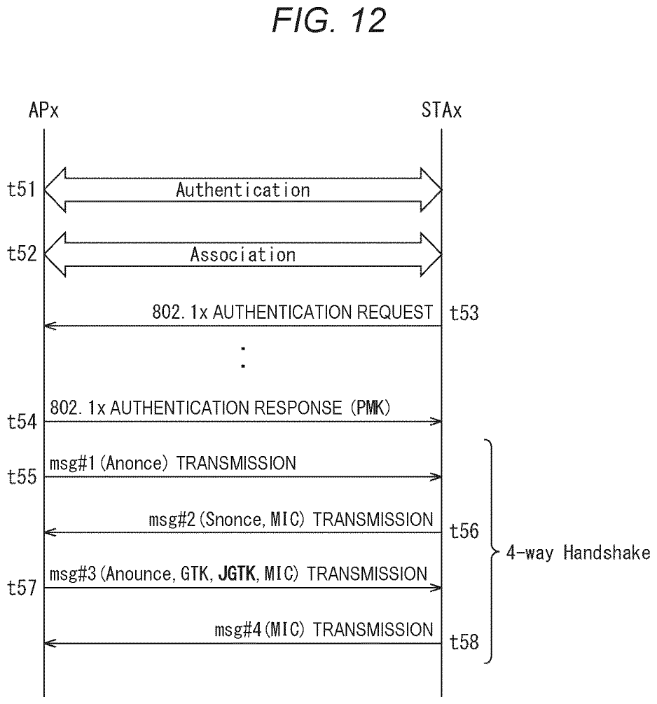

FIG. 12 is a diagram illustrating a sequence in the Link Setup Phase.

The sequence in the Link Setup Phase in FIG. 12 is a common sequence between AP1 and STA1 and between AP2 and STA2.

At timing t51, the AP and the STA perform Authentication (set WEP encryption or do nothing).

At timing t52, the AP and the STA perform Association (connection processing).

At timing t53, the STA transmits an 802.1x authentication request to the authentication node to obtain authentication to the LAN connection.

Note that the authentication node here is generally connected to the AP via an Internet line in many cases, and the STA needs to transmit a request signal to the AP.

The AP receives the 802.1x authentication request transmitted from the STA. Thereafter, at timing t54, the AP transmits an 802.1x authentication response signal, and at the same time, transmits a PMK which is a public key necessary for generating an encryption key.

Furthermore, although omitted in FIG. 12, actually, after information exchange is performed several times, the STA acquires the PMK, which is the public key necessary for generating the encryption key, at the same time of acquiring the 802.1x authentication response signal. As a result, at least the AP and the STA hold the same PMK information. Note that, in a case where authentication of 802.1x is not necessary and PMK setting has already been performed, the processing at timings t53 and t54 is skipped.

At timing t55 to t58, the AP and the STA perform 4-way Handshake. In FIG. 12, the JGTK information is included in the 4-way Handshake msg#3.

Specifically, at timing t55, the AP transmits a 4-way Handshake msg#1 frame including the Anonce to the STA.

The STA receives a 4-way Handshake msg#1 frame transmitted from the AP. Thereafter, at timing t56, the STA transmits a 4-way Handshake msg#2 frame including the Snonce and the MIC to the AP.

The AP receives a 4-way Handshake msg#2 frame transmitted from the STA. Thereafter, at timing t57, the AP transmits a 4-way Handshake msg#3 frame including the Anonce, GTK, JGTK, and MIC to the STA.

The STA receives a 4-way Handshake msg#3 frame transmitted from the AP. At this time, the STA acquires GTK and JGTK. Thereafter, at timing t58, the STA transmits a 4-way Handshake msg#4 frame including the MIC to the AP.

The AP receives a 4-way Handshake msg#4 frame transmitted from the STA. Thereafter, the sequence of FIG. 12 ends.

### Configuration of 4-Way Handshake msg#3 Frame

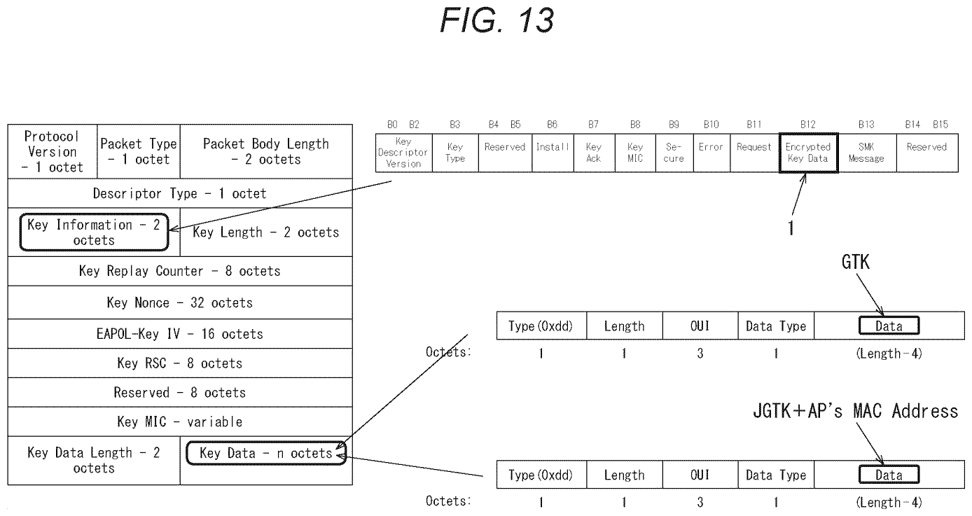

FIG. 13 is a diagram illustrating a configuration example of a 4-way Handshake msg#3 frame.

Note that, in FIG. 13, since the 4-way Handshake msg#3 frame has a frame configuration basically similar to that of the JGTK Handshake msg#1 frame in FIG. 6, only portions different from those of the JGTK Handshake msg#1 frame in FIG. 6 will be described.

The Encrypted Key Data of the Key Information is information indicating that the subsequent Key Data is encrypted, and 1 is described in the case of FIG. 13.

The GTK information is included in a Data field of one or a plurality of KDE formats included in the Key Data. The GTK information is information indicating a shared GTK. Note that a notification indicating that the GTK information is included in the Key Data is given in the Type field. The GTK information is encrypted using a secret key (Pairwise Temporary Key, hereinafter referred to as PTK) generated prior to transmitting this frame.

The JGTK information is included in a Data field of one or a plurality of KDE formats included in the Key Data. The GTK information is information indicating a shared JGTK. Note that a notification indicating that the JGTK information is included in the Key Data is given in the Type field. The JGTK information is encrypted using the previously generated PTK.

In addition, only in a case where the JGTK is generated by Handshake, the AP's MAC Address is also included in the Data field of one or a plurality of KDE formats together with the JGTK information. Note that a notification indicating that AP's MAC Address information is indicated in the Key Data is given in the Type field. The AP's MAC Address is encrypted using the previously generated PTK.

The AP's MAC Address is identification information (other than the connection destination AP) for identifying the AP of the coordination partner of the Joint Tx to which the JGTK is applied. The identification information is MAC address information in the case of FIG. 13, but may be other identification information. Note that, in a case where the JGTK is distributed from a certain AP, this field indicates a broadcast address.

In a case where a tag number is assigned to each combination of APs performing the Joint Tx, the tag number may be notified as the identification information instead of the MAC address.

### Processing of STA

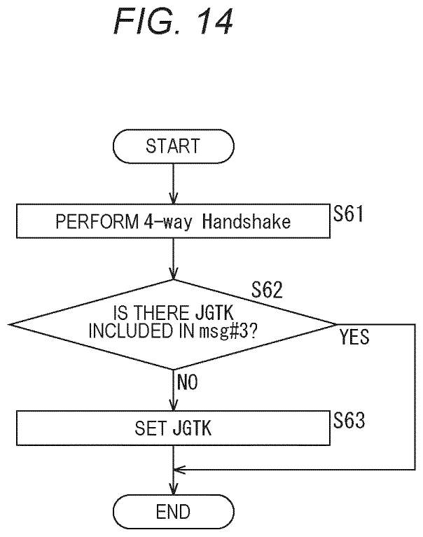

FIG. 14 is a flowchart for explaining processing of the STA.

Note that the processing of FIG. 14 is processing performed by the communication control unit 155 of the STA controlling each unit of the wireless communication unit 131.

In step S61, the communication control unit 155 of the STA performs 4-way Handshake with the AP as described above with reference to FIG. 12. At that time, the communication control unit 155 receives a 4-way Handshake msg#3 frame transmitted from the AP.

In step S62, the communication control unit 155 determines whether or not JGTK is included in the 4-way Handshake msg#3 frame. In a case where it is determined that the JGTK is not included in the 4-way Handshake msg#3 frame, the process of FIG. 14 ends.

In step S62, in a case where it is determined that the JGTK is included in the 4-way Handshake msg#3 frame, the process proceeds to step S63.

In step S63, the communication control unit 155 stores the JGTK together with the AP's MAC Address in the communication storage unit 156 or the like, and sets the JGTK as a key used at the time of Joint Tx. Thereafter, the process of FIG. 14 ends.

Note that, in a case where the STA is not compatible with the Joint Tx due to the Capability problem, the JGTK may be discarded without being stored.

### 2. Second Embodiment

### System Configuration

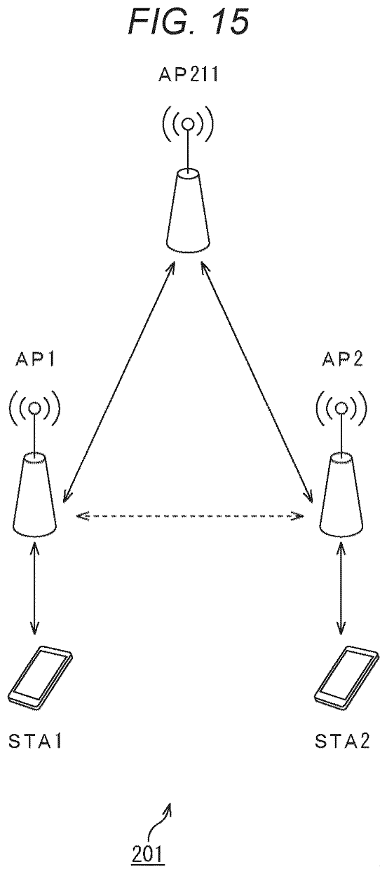

FIG. 15 is a diagram illustrating a configuration example of a wireless communication system according to a second embodiment of the present technology.

A wireless communication system 201 of FIG. 15 is different from the wireless communication system 1 of FIG. 1 in that AP211 is added.

Each of AP1 and AP2 can reliably communicate with AP211, but it is not always possible to directly communicate between AP1 and AP2.

In the wireless communication system 201, AP211 controls the Joint Tx of AP1 and AP2. That is, either the sequence of generating the JGTK used in the Joint Tx between AP1 and AP2 by AP211 or the sequence of generating the JGTK by AP1 and AP2 according to the instruction of AP211 is performed.

Note that, in FIG. 15, AP211 may be in an apparatus form different from that of AP1 and AP2 (for example, Controller), or may be an existence that plays a different role (for example, Master AP). Hereinafter, in the second embodiment, for the sake of simplicity, AP211 is referred to as a “control AP”, and the others of AP1 and AP2 are referred to as “non-control APs”.

In addition, the overall sequence of the wireless communication system 201 is configured by the Joint Tx Setup Phase of Ph1 and the Link Setup Phase of Ph2 similarly to the overall sequence of the wireless communication system 1 described above with reference to FIG. 4, and thus illustration thereof is omitted.

In addition, since the Link Setup Phase of Ph2 of the wireless communication system 201 is similar to the Link Setup Phase of the wireless communication system 1 described above with reference to FIG. 12, the description thereof will be omitted. Therefore, the Joint Tx Setup Phase of the wireless communication system 201 will be described below.

### Third Sequence in Joint Tx Setup Phase

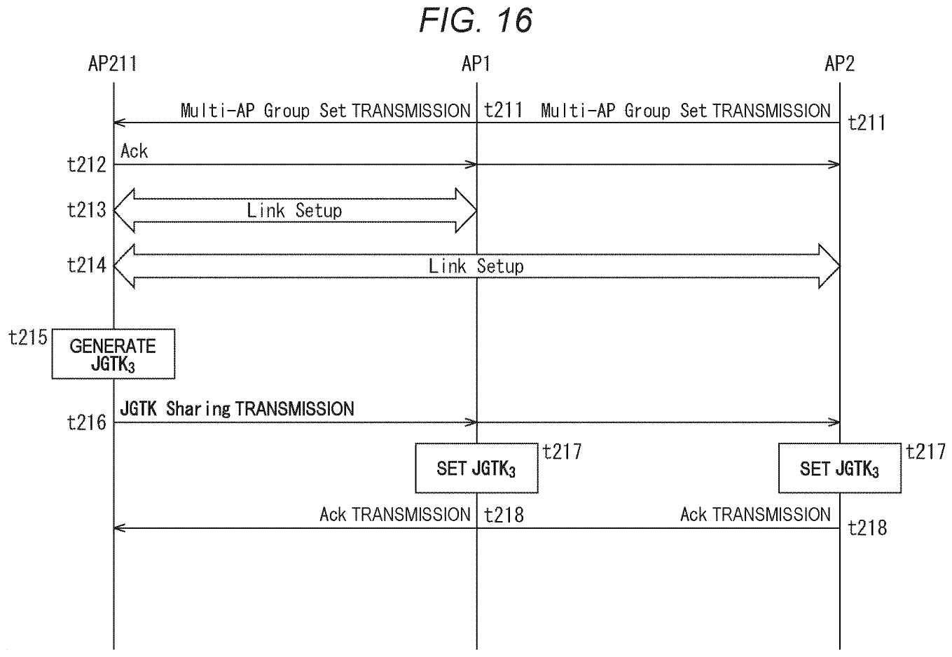

FIG. 16 is a diagram illustrating a third sequence for AP211, AP1, and AP2 to share the same JGTK in the Joint Tx Setup Phase.

FIG. 16 illustrates a sequence of distributing the JGTK₃ generated by AP211 to AP1 and AP2 as the third sequence. Note that the basic processing in FIG. 16 is similar to the second sequence described above with reference to FIG. 8.

At timing t211, AP1 and AP2 transmit a Multi-AP Group Set frame to AP211, and set a group for performing cooperative communication.

AP211 receives the Multi-AP Group Set frame, and transmits an Ack to AP1 and AP2 at timing t212. AP1 and AP2 receive the Ack.

AP211 and AP1 perform link setup between AP211 and AP1 at timing t213. The link setup mainly establishes a method for exchanging control signals between AP211 and AP1.

AP211 and AP2 perform link setup between AP211 and AP2 at timing t214. The link setup mainly establishes a method for exchanging control signals between AP211 and AP2.

At timing t215, AP211 generates the JGTK₃ only with its own held parameters.

At timing t216, AP211 transmits a JGTK Sharing frame including the generated JGTK₃ to the other APs (AP1 and AP2 in the case of FIG. 16).

AP1 and AP2 receive the JGTK Sharing frame. At timing t217, AP1 and AP2 set the received JGTK₃ as keys to be used at the time of the Joint Tx.

At timing t218, AP1 and AP2 transmit Acks to AP211. AP211 receives the Acks transmitted from AP1 and AP2.

As described above, the JGTK₃ is shared by AP211, AP1, and AP2. In the third sequence, since AP211 that is a control AP generates the JGTK₃ and transmits the JGTK₃ to the AP1 and AP2 that are non-control APs, the third sequence can be applied even in a case where there are three or more APs that perform cooperative communication.

Meanwhile, since it is necessary to wirelessly transmit the JGTK as it is, there is a risk that the secret key is leaked as it is when the radio wave is intercepted.

Note that, here, JGTK₃ represents a secret key used when Joint Tx is performed by a combination of AP1, AP2, and AP3, and a similar secret key may be used when Joint Tx of another combination of APs is performed.

### Fourth Sequence in Joint Tx Setup Phase

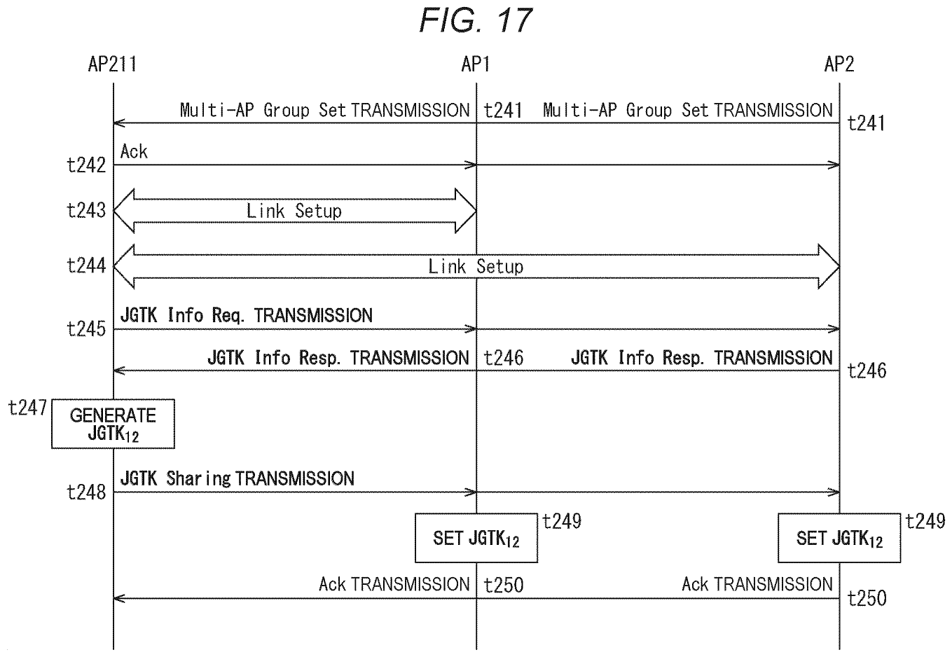

FIG. 17 is a diagram illustrating a fourth sequence for AP1 and AP2 to share the same JGTK in the Joint Tx Setup Phase.

FIG. 17 illustrates, as the fourth sequence, a sequence in which AP211 that is a control AP generates the JGTK₁₂ used only by the pair of AP1 and AP2 that are non-control AP, and distributes the JGTK₁₂ generated by AP211 to AP1 and AP2.

Since the processing at the timings t241 to t244 in FIG. 17 is similar to the processing at the timings t211 to t214 in FIG. 16, the description thereof will be omitted.

At timing t245, AP211 transmits a JGTK Info Request frame requesting information (random number information) necessary for generating the JGTK₁₂ from AP1 and AP2 to AP1 and AP2. AP1 and AP2 receive the JGTK Info Request frame. The JGTK Info Request frame includes PMK information.

At timing t246, AP1 and AP2 transmit JGTK Info Response frames each including information (random number information) necessary for generating the JGTK₁₂. AP211 receives JGTK Info Response frames transmitted from AP1 and AP2, respectively.

At timing t247, AP211 generates the JGTK₁₂ on the basis of the information included in the received JGTK Info Response frame.

Note that the processing at the timings t248 to t250 in FIG. 17 is basically similar to the processing at the timings t216 to t218 in FIG. 16, and thus the description thereof will be omitted.

As described above, the JGTK₁₂ is shared by AP1 and AP2. That is, the JGTK generated by the fourth sequence is used according to a combination of APs that perform coordinated transmission together.

### Configuration of JGTK Info Request Frame

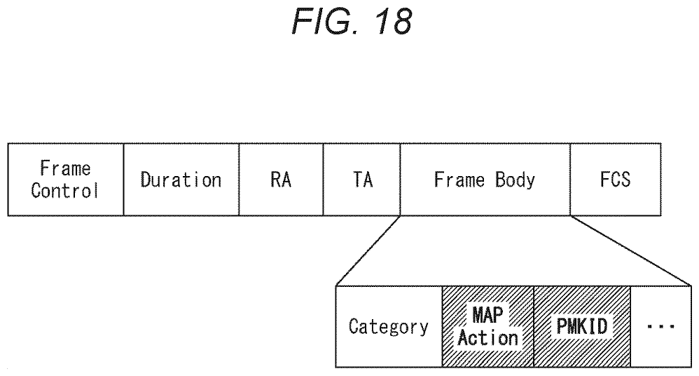

FIG. 18 is a diagram illustrating a configuration example of a JGTK Info Request frame.

The JGTK Info Request frame in FIG. 18 includes each field of Frame Control, Duration, Receiver Address (RA), Transmitter Address (TA), Frame Body, and Frame Check Sequence (FCS).

The Frame Body includes at least Category, MAP Action, and PMKID.

The MAP Action is information indicating that this frame is a JGTK Info Request.

The PMKID is PMK information used when the JGTK is generated.

Note that, in FIG. 18, a JGTK Info Request frame is illustrated on the basis of an Action frame of IEEE802.11. However, in the present technology, the frame configuration is not limited to the frame configuration of FIG. 18, and at least the MAP Action and the PMKID described above are only required to be included.

Furthermore, the JGTK Info Request frame in FIG. 18 is described on the assumption of a MAC Frame, but may be transmitted as a TCP/IP Frame as long as the above information is described.

### Configuration of JGTK Info Response Frame

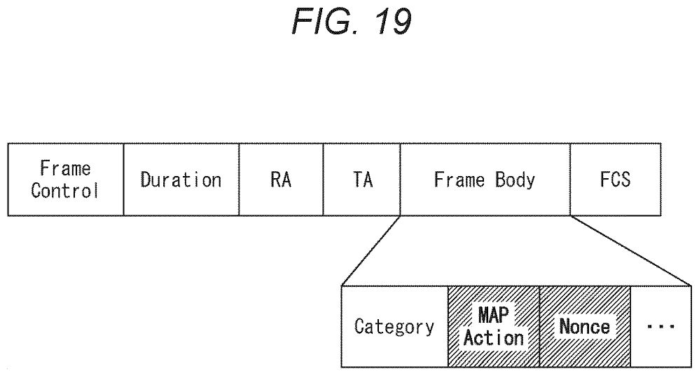

FIG. 19 is a diagram illustrating a configuration example of a JGTK Info Response frame.

The JGTK Info Request frame of FIG. 19 is basically configured similarly to the JGTK Info Request frame of FIG. 18, and thus, only portions different from the JGTK Info Request frame of FIG. 18 will be described.

The Frame Body in FIG. 19 includes at least Category, MAP Action, and Nonce.

The MAP Action is information indicating that this frame is JGTK Info Response.

The Nonce is random number information used to generate the JGTK.

### Fifth Sequence in Joint Tx Setup Phase

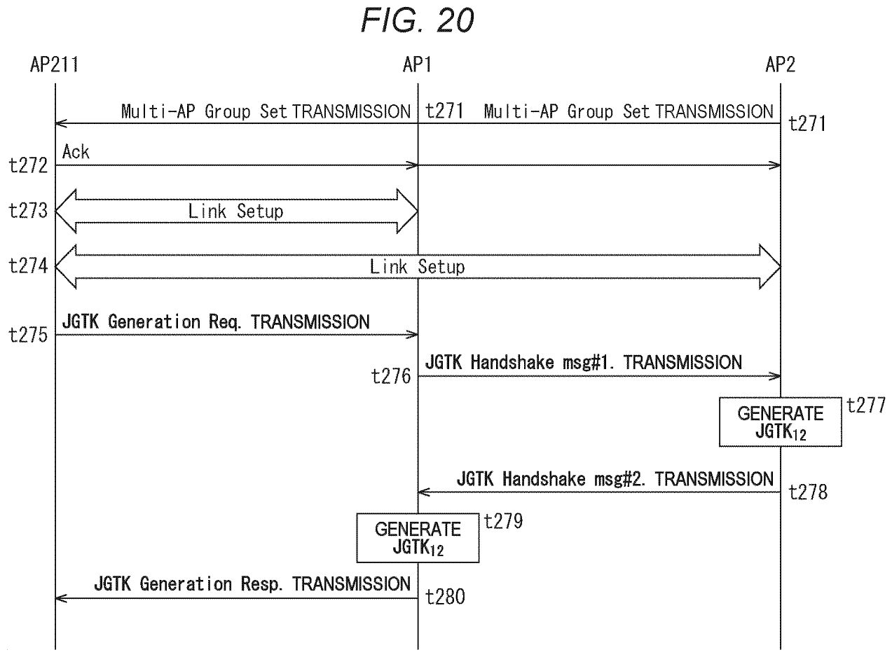

FIG. 20 is a diagram illustrating a fifth sequence for AP1 and AP2 to share the same JGTK in the Joint Tx Setup Phase.

FIG. 20 illustrates, as a fifth sequence, a sequence in which AP1 and AP2 directly exchange and generate the JGTK₁₂ dedicated to the Joint Tx of AP1 and AP2 that are non-control APs according to an instruction of AP211 that is a control AP.

Since the processing at the timings t271 to t274 in FIG. 20 is similar to the processing at the timings t211 to t214 in FIG. 16, the description thereof will be omitted.

At timing t275, AP211 transmits a JGTK Generation Request frame to either AP1 or AP2 (AP1 in the case of FIG. 20). AP1 receives the JGTK Generation Request frame.

Since the processing at the timings t276 to t279 is basically similar to the processing at the timings t14 to t17 in FIG. 5, the description thereof will be omitted. That is, during this time, direct exchange is performed by AP1 and AP2, and the JGTK₁₂ dedicated to the Joint Tx is generated in AP1 and AP2.

At timing t280, AP1 transmits a JGTK Generation Response frame including information indicating whether the generation of the JGTK₁₂ has succeeded or failed to AP211. Thereafter, the sequence of FIG. 20 ends.

As described above, the JGTK₁₂ is shared by AP1 and AP2. That is, the JGTK generated by the fifth sequence is used according to a combination of APs that perform coordinated transmission together, similarly to the JGTK generated by the fourth sequence.

### Configuration of JGTK Generation Request Frame

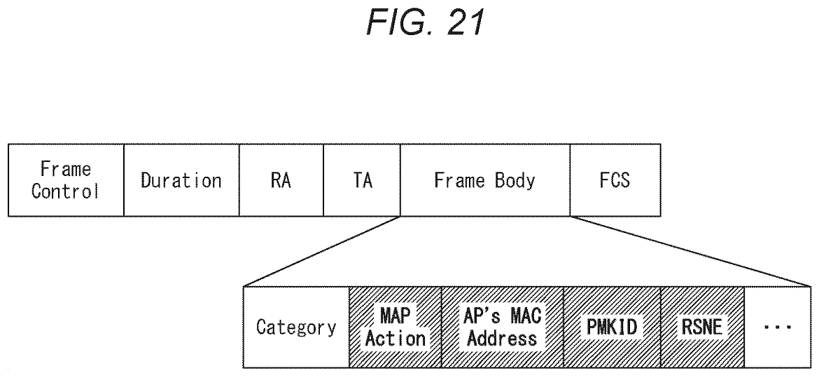

FIG. 21 is a diagram illustrating a configuration example of a JGTK Generation Request frame.

Since the JGTK Generation Request frame in FIG. 21 is basically configured similarly to the JGTK Info Request frame in FIG. 18, only portions different from the JGTK Info Request frame in FIG. 18 will be described.

The Frame Body in FIG. 21 includes at least Category, MAP Action, AP's MAC Address, PMKID, and RSNE.

The MAP Action is information indicating that this frame is a JGTK Generation Request frame.

The AP's MAC Address is address information of a partner AP (for example, AP1) that is to generate a JGTK together with the request destination of this Request frame (for example, AP2).

The PMKID is PMK information used when the JGTK is generated.

The RSNE is encryption scheme information of the above-described partner AP.

### Configuration of JGTK Generation Response Frame

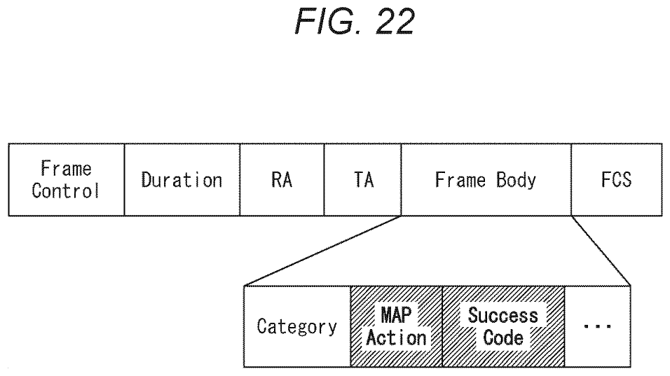

FIG. 22 is a diagram illustrating a configuration example of a JGTK Generation Response frame.

Since the JGTK Generation Response frame in FIG. 22 is basically configured similarly to the JGTK Info Request frame in FIG. 18, only portions different from the JGTK Info Request frame in FIG. 18 will be described.

The Frame Body in FIG. 22 includes at least Category, MAP Action, and Success Code.

The MAP Action is information indicating that this frame is a JGTK Generation Response.

The Success Code is information indicating whether generation of the JGTK has succeeded or failed. Note that, in the case of failure, the Success Code may include information indicating a reason (Reason Code).

### Processing of Control AP

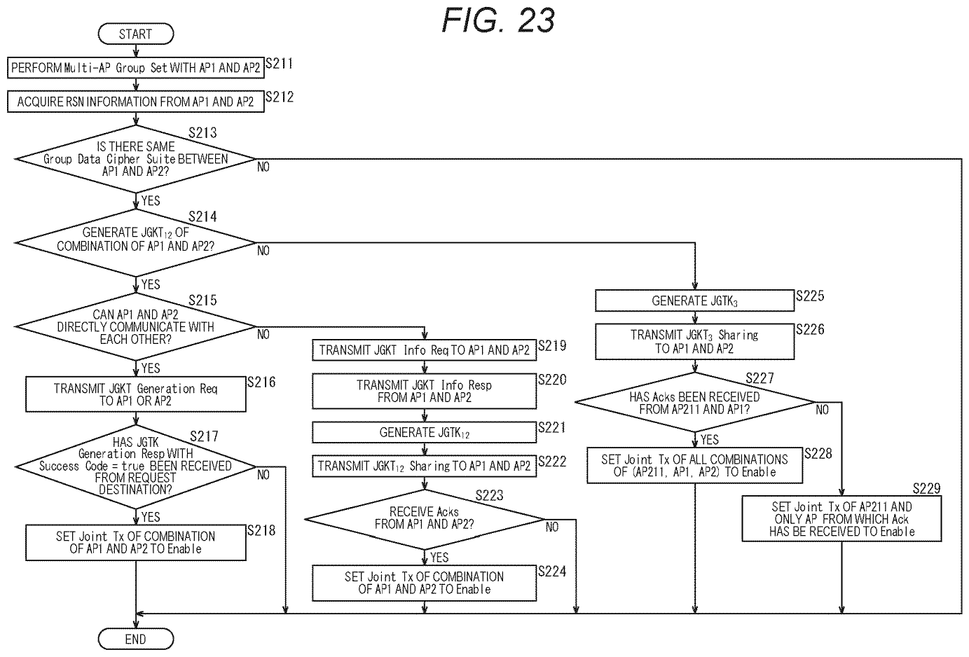

FIG. 23 is a flowchart for explaining processing of the control AP (AP211).

Note that FIG. 23 illustrates an example in a case where AP211 selects the method of generating the JGTK to be used between AP1 and AP2. Furthermore, the processing of FIG. 23 is processing performed by the communication control unit 55 of AP211 controlling each unit of the wireless communication unit 31.

In step S211, the communication control unit 55 of AP211 performs Multi-AP Group Set with each of AP1 and AP2 (for example, timings t1 and t2 in FIG. 20).

In step S212, the communication control unit 55 acquires information (RSNE) for generating encryption keys of AP1 and AP2 from each Multi-AP Group Set flame.

In step S213, the communication control unit 55 determines whether or not there is the same Group Data Cipher Suite between AP1 and AP2.

In a case where there is no scheme that is the same as Group Data Chipper Suite in which AP1 and AP2 are compatible with each other, it is determined in step S213 that there is no same Group Data Cipher Suite, and the process of FIG. 23 ends. Note that, at this time, AP1 and AP2 may be notified of the fact that the Joint Tx cannot be performed between AP1 and AP2.

In a case where there is at least one Group Data Chipper Suite that can be commonly used by AP1 and AP2, it is determined in step S213 that there is the same Group Data Cipher Suite, and the process proceeds to step S214.

In step S214, the communication control unit 55 determines whether to generate a common secret key only for AP1 and AP2 (fourth or fifth sequence) or to uniformly generate and notify AP1 and AP2 (third sequence). The determination criterion in step S214 is as described above with reference to FIG. 10.

In a case where it is determined in step S214 that a common secret key is generated only for AP1 and AP2, the process proceeds to step S215.

In step S215, the communication control unit 55 determines whether or not AP1 and AP2 can directly communicate with each other. At this time, whether or not direct communication is possible may be determined by obtaining detectable AP information or the like at the time of Multi-AP Group Set. If the information related to the radio wave environment has not been acquired, it may be determined that “direct communication is impossible”.

In a case where it is determined in step S215 that AP1 and AP2 can directly communicate with each other, the process proceeds to step S216.

In step S216, the communication control unit 55 transmits a JGKT Generation Req frame to AP1 or AP2 (for example, timing t275 in FIG. 20).

AP1 receives the JGKT Generation Req frame and communicates with AP2 to generate the JGKT₁₂. After generating the JGKT₁₂, AP1 transmits a JGTK Generation Resp frame including information indicating successful generation of the JGKT₁₂ (for example, timing t280 in FIG. 20).

In step S217, the communication control unit 55 determines whether or not a JGTK Generation Resp frame with Success Code=true has been received from AP1 that is a request destination of the JGKT Generation Req frame. In a case where it is determined in step S217 that the JGTK Generation Resp frame has been received from the request destination, the process proceeds to step S218.

In step S218, the communication control unit 55 sets the Joint Tx of the combination of AP1 and AP2 to Enable. Thereafter, the process of FIG. 23 ends.

In step S217, also in a case where the communication control unit 55 receives the JGTK Generation Resp frame with Success Code=false from the request destination, or in a case where it is determined that the JGTK Generation Resp frame has not been received from the request destination, the process of FIG. 23 ends. Specifically, in a case where there is no response from the request destination for a certain period of time, or in a case where a JGTK Generation Resp frame including information indicating failure of generation of the JGKT₁₂ is received, the processing is interrupted as it is. Note that, if possible, AP211 may retransmit the Same JGKT Generation Req frame.

In a case where it is determined in step S215 that AP1 and AP2 cannot directly communicate with each other, the process proceeds to step S219.

In step S219, the communication control unit 55 transmits a JGKT Info Req frame to each of AP1 and AP2 (for example, timing t245 in FIG. 17).

AP1 and AP2 receive the JGKT Info Req frame and transmit a JGKT Info Resp frame (for example, timing t246 in FIG. 17).

In step S220, the communication control unit 55 receives the JGKT Info Resp frame transmitted from AP1 and AP2.

In step S221, the communication control unit 55 generates the JGTK₁₂ on the basis of the JGKT Info Resp frame transmitted from AP1 and AP2 (for example, timing t247 in FIG. 17).

In step S222, the communication control unit 55 transmits a JGKT Sharing frame including the JGTK₁₂ to each of AP1 and AP2 (for example, timing t248 in FIG. 17).

AP1 and AP2 Receive the JGKT Sharing Frame, Set the JGTK₁₂ as a key used at the time of Joint Tx, and transmit Ack (for example, timing t250 in FIG. 17).

In step S223, the communication control unit 55 receives Acks transmitted from AP1 and AP2. Note that, also at this time, in a case where there is no response from AP1 or AP2 for a certain period of time, the processing is interrupted as it is. In addition, the communication control unit 55 of AP211 may retransmit the same JGKT Sharing frame if possible.

In step S224, the communication control unit 55 sets the Joint Tx of the combination of AP1 and AP2 to Enable. Thereafter, the process of FIG. 23 ends.

Meanwhile, in step S214, in a case where it is determined to uniformly generate and notify AP1 and AP2, the process proceeds to step S225.

In step S225, the communication control unit 55 generates the JGTK₃ by itself (for example, timing t216 in FIG. 16).

In step S226, the communication control unit 55 transmits a JGTK Sharing frame including the generated JGTK₃ to AP1 and AP2 (for example, timing t217 in FIG. 16).

AP1 and AP2 receive the JGTK Sharing frame, set the JGTK₃ as a key used at the time of Joint Tx, and transmit Ack (for example, timing t218 in FIG. 16).

In step S227, the communication control unit 55 determines whether or not Acks transmitted from AP1 and AP2 have been received. In a case where it is determined in step S227 that the Acks has been received, the process proceeds to step S228.

In step S228, the communication control unit 55 sets the Joint Tx of all combinations of (AP211, AP1, AP2) to Enable. Thereafter, the process of FIG. 23 ends.

In a case where it is determined in step S227 that the Ack from at least one of AP1 or AP2 has not been received, the process proceeds to step S229.

In step S229, the communication control unit 55 sets the Joint Tx of AP211 and only the AP from which the Ack has be received to Enable. Note that, in step S229, in a case where the Acks have not been received from both, the Joint Tx of all combinations is set as Disable. Thereafter, the process of FIG. 23 ends.

### Processing of Non-Control AP

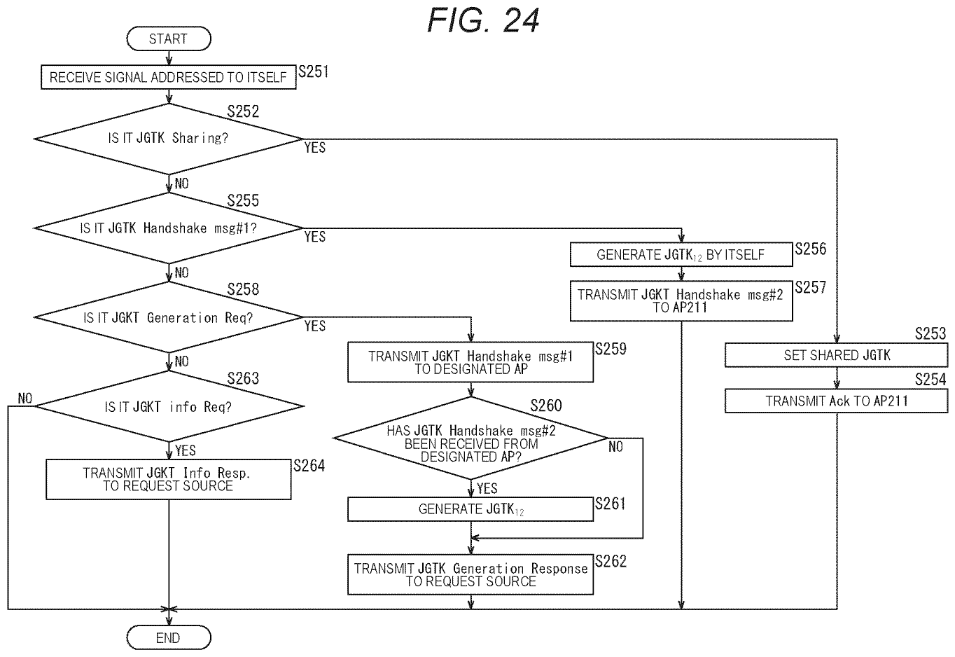

FIG. 24 is a flowchart for explaining processing of the non-control AP (AP1).

Note that the processing in steps S251 to S257 in FIG. 24 is similar to the processing in steps S41 to S47 in FIG. 11 except that the communication partner is different, and thus the description thereof will be omitted. Furthermore, the processing of FIG. 24 is processing performed by the communication control unit 55 of AP1 controlling each unit of the wireless communication unit 31.

In a case where it is determined in step S255 that the signal is not a JGTK Handshake msg#1 frame, the process proceeds to step S258.

In step S258, the communication control unit 55 of AP1 determines whether or not the received signal is a JGKT Generation Request frame.

In a case where it is determined in step S258 that the received signal is the JGTK Generation Request frame, the process proceeds to step S259.

In step S259, the communication control unit 55 transmits a JGKT Handshake msg#1 frame to the designated AP (for example, AP2) (for example, timing t276 in FIG. 20).

AP2 receives the JGKT Handshake msg#1 frame, generates the JGTK₁₂, and transmits the JGKT Handshake msg#2 frame to AP1 (for example, timing t278 in FIG. 20).

In step S260, the communication control unit 55 determines whether or not a JGTK Handshake msg#2 frame has been received from AP2. In a case where it is determined in step S260 that the JGTK Handshake msg#2 frame has been received from AP2, the process proceeds to step S261.

In step S261, the communication control unit 55 generates the JGTK₁₂ on the basis of the received JGTK Handshake msg#2 frame (for example, timing t279 in FIG. 20).

In step S262, the communication control unit 55 transmits a JGTK Generation Response frame indicating successful generation of the JGTK₁₂ to the request source (AP211) that has transmitted the JGTK Generation Request frame (for example, timing t280 in FIG. 20). Thereafter, the process of FIG. 24 ends.

In a case where it is determined in step S260 that the JGTK Handshake msg#2 frame has not been received from AP2 within a certain period of time, for example, the process of step S261 is skipped, and the process proceeds to step S262.

In this case, in step S262, the communication control unit 55 transmits a JGTK Generation Response frame notifying that the JGTK₁₂ generation has failed to the request source (AP211) that has transmitted the JGTK Generation Request frame. Thereafter, the process of FIG. 24 ends. Note that retransmission of the JGKT Handshake msg#1 frame may be performed several times.

Meanwhile, in a case where it is determined in step S258 that the signal is not a JGTK Generation Request frame, the process proceeds to step S263.

In step S263, the communication control unit 55 determines whether or not the received signal is a JGTK info Request frame. In a case where it is determined in step S263 that the received signal is the JGTK info Request frame, the process proceeds to step S264.

In step S264, the communication control unit 55 transmits a JGKT Info Response frame to the request source (AP211) (for example, timing t246 in FIG. 17). Thereafter, the process of FIG. 24 ends. In this case, thereafter, the JGTK is generated by AP211, a JGTK Sharing frame is transmitted from AP211, and the process of FIG. 24 is repeated again.

In a case where it is determined in step S263 that the received signal is not a JGTK info Request frame, the process of FIG. 24 ends.

### 3. Others

### Effects of Present Technology

In the present technology, a communication apparatus (AP1) shares a first secret key (JTGK) for coordinated transmission and for groupcasting, which is used when performing coordinated transmission with one or a plurality of other communication apparatuses (AP2) to a communication terminal (STA), with other communication apparatuses.

Therefore, according to the present technology, by distributing the JGTK generated between the APs to the STAs, when a plurality of APs performs data transmission in the Joint Tx, the APs can uniformly perform encryption using the secret key JGTK and start transmission regardless of the destination STA. Furthermore, similarly, when receiving data in the Joint Tx, the STA can acquire data necessary for itself by releasing the encryption using the JGTK suitable for the combination of APs for coordinated transmission.

The encryption key for the groupcast is easy to manage even if the number of STAs increases. In addition, since the Joint Tx physically forms a high-dimensional beam, even if the secret key dedicated to the Joint Tx leaks, it is difficult for the third party to intercept the packet transmitted by the Joint Tx.

As described above, according to the present technology, the AP does not need to know the individual secret keys (PTK) of all the STAs belonging to other BSSs, and the secret keys can be easily managed.

### Configuration Example of Computer

The above-described series of processing can be executed by hardware or software. In a case where the series of processing is executed by software, a program constituting the software is installed from a program recording medium to a computer incorporated in dedicated hardware, a general-purpose personal computer, or the like.

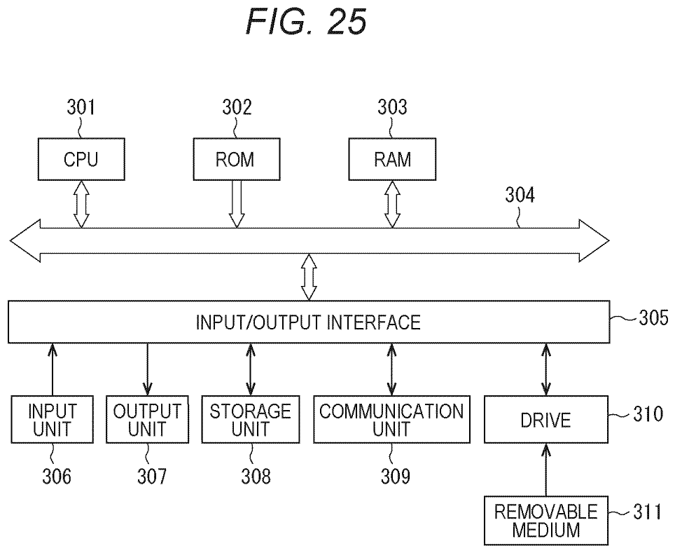

FIG. 25 is a block diagram illustrating a configuration example of hardware of a computer that executes the above-described series of processing by a program.

A central processing unit (CPU) 301, a read only memory (ROM) 302, and a random access memory (RAM) 303 are mutually connected by a bus 304.

An input/output interface 305 is further connected to the bus 304. An input unit 306 including a keyboard, a mouse, and the like, and an output unit 307 including a display, a speaker, and the like are connected to the input/output interface 305. Furthermore, a storage unit 308 including a hard disk, a nonvolatile memory, and the like, a communication unit 309 including a network interface and the like, and a drive 310 that drives a removable medium 311 are connected to the input/output interface 305.

In the computer configured as described above, for example, the CPU 301 loads a program stored in the storage unit 308 into the RAM 303 via the input/output interface 305 and the bus 304 and executes the program, whereby the above-described series of processing is performed.

The program executed by the CPU 301 is provided, for example, by being recorded in the removable medium 311 or via a wired or wireless transmission medium such as a local area network, the Internet, or digital broadcasting, and is installed in the storage unit 308.

Note that the program executed by the computer may be a program in which processing is performed in time series in the order described in the present specification, or may be a program in which processing is performed in parallel or at necessary timing such as when a call is made.

Note that, in the present specification, a system means a set of a plurality of components (apparatuses, modules (parts), or the like), and it does not matter whether or not all the components are in the same housing. Therefore, a plurality of apparatuses housed in separate housings and connected via a network and one apparatus in which a plurality of modules is housed in one housing are both systems.

Furthermore, the effects described in the present specification are merely examples and are not limited, and other effects may be provided.

The embodiments of the present technology are not limited to the above-described embodiments, and various modifications can be made without departing from the gist of the present technology.

For example, the present technology can have a configuration of cloud computing in which one function is shared and processed in cooperation by a plurality of apparatuses via a network.

Furthermore, each step described in the above-described flowcharts can be executed by one apparatus or can be shared and executed by a plurality of apparatuses.

Furthermore, in a case where a plurality of processes is included in one step, the plurality of processes included in the one step can be executed by one apparatus or can be shared and executed by a plurality of apparatuses.

### Combination Example of Configuration

The present technology can also have the following configurations.
(1)

A communication apparatus including
a communication control unit that shares a first secret key for coordinated transmission and groupcast, which is used when the coordinated transmission is performed on a communication terminal together with one or a plurality of other communication apparatuses, with the other communication apparatuses.
(2)

The communication apparatus according to (1),
in which the communication control unit notifies the communication terminal of the first secret key together with a second secret key for groupcast.
(3)

The communication apparatus according to (2),
in which the communication control unit notifies the communication terminal of the first secret key together with identification information indicating the other communication apparatuses that perform the coordinated transmission to which the first secret key is applied.
(4)

The communication apparatus according to any one of (1) to (3),
in which the communication control unit selectively uses the first secret key according to the number of the other communication apparatuses that perform the coordinated transmission together and identification information.
(5)

The communication apparatus according to any one of (1) to (3), further including
a generation unit that generates the first secret key,
in which the communication control unit shares the first secret key generated with one or a plurality of the other communication apparatuses.
(6)

The communication apparatus according to any one of (1) to (3), further including
a generation unit that generates the first secret key same as that of the other communication apparatuses by exchanging information with the other communication apparatuses.
(7)

The communication apparatus according to any one of (1) to (3),
in which the communication control unit requests at least one of the other communication apparatuses to generate the first secret key among the plurality of the other communication apparatuses.
(8)

The communication apparatus according to (7),
in which the communication control unit acquires, from at least one of the other communication apparatuses, a generation result as to whether or not the first secret key has been successfully generated among the plurality of the other communication apparatuses.
(9)

The communication apparatus according to any one of (1) to (3),
in which the communication control unit requests information necessary for generating the first secret key from a plurality of the other communication apparatuses.
(10)

The communication apparatus according to (9),
in which the communication control unit acquires the information necessary for generating the first secret key from a plurality of the other communication apparatuses, generates the first secret key, and transmits the first secret key to the other communication apparatuses.
(11)

A communication method in which
a communication apparatus is configured to
share a secret key for coordinated transmission and groupcast, which is used when the coordinated transmission is performed on a communication terminal together with one or a plurality of other communication apparatuses, with the other communication apparatuses.
(12)

A communication terminal including
a communication control unit that selects a first secret key to be used for decryption on the basis of identification information indicating a communication apparatus that performs coordinated transmission together using the first secret key for the coordinated transmission and groupcast when a signal is received by the coordinated transmission by a plurality of communication apparatuses.
(13)

The communication terminal according to (12),
in which the communication control unit acquires the first secret key simultaneously with a second secret key for groupcast notified from the communication apparatus.
(14)

The communication terminal according to (12) or (13), further including
a storage unit that stores the identification information together with the first secret key.
(15)

A communication method in which
a communication terminal is configured to
set a first secret key to be used for decryption on the basis of identification information indicating a communication apparatus that performs coordinated transmission together using the first secret key for the coordinated transmission and groupcast when a signal is received by the coordinated transmission by a plurality of communication apparatuses.

### REFERENCE SIGNS LIST

1 Wireless communication system
11 Communication apparatus
31 Wireless communication unit 32 Control unit
33 Storage unit
34 WAN communication unit
41 Antenna
51 Amplification unit
52 Wireless interface unit
53 Signal processing unit
54 Data processing unit
55 Communication control unit
56 Communication storage unit
111 Communication apparatus
131 Wireless communication unit 132 Control unit
133 Storage unit
134 WAN communication unit
141 Antenna
151 Amplification unit
152 Wireless interface unit
153 Signal processing unit
154 Data processing unit
155 Communication control unit
156 Communication storage unit

1. A communication apparatus comprising
a communication control unit that shares a first secret key for coordinated transmission and groupcast, which is used when the coordinated transmission is performed on a communication terminal together with one or a plurality of other communication apparatuses, with the other communication apparatuses.

2. The communication apparatus according to claim 1,
wherein the communication control unit notifies the communication terminal of the first secret key together with a second secret key for groupcast.

3. The communication apparatus according to claim 2,
wherein the communication control unit notifies the communication terminal of the first secret key together with identification information indicating the other communication apparatuses that perform the coordinated transmission together to which the first secret key is applied.

4. The communication apparatus according to claim 1,
wherein the communication control unit selectively uses the first secret key according to the number of the other communication apparatuses that perform the coordinated transmission together and identification information.

5. The communication apparatus according to claim 1, further comprising
a generation unit that generates the first secret key,
wherein the communication control unit shares the first secret key generated with one or a plurality of the other communication apparatuses.

6. The communication apparatus according to claim 1, further comprising
a generation unit that generates the first secret key same as that of the other communication apparatuses by exchanging information with the other communication apparatuses.

7. The communication apparatus according to claim 1,
wherein the communication control unit requests at least one of the other communication apparatuses to generate the first secret key among the plurality of the other communication apparatuses.

8. The communication apparatus according to claim 7,
wherein the communication control unit acquires, from at least one of the other communication apparatuses, a generation result as to whether or not the first secret key has been successfully generated among the plurality of the other communication apparatuses.

9. The communication apparatus according to claim 1,
wherein the communication control unit requests information necessary for generating the first secret key from a plurality of the other communication apparatuses.

10. The communication apparatus according to claim 9,
wherein the communication control unit acquires the information necessary for generating the first secret key from a plurality of the other communication apparatuses, generates the first secret key, and transmits the first secret key to the other communication apparatuses.

11. A communication method in which
a communication apparatus is configured to
share a secret key for coordinated transmission and groupcast, which is used when the coordinated transmission is performed on a communication terminal together with one or a plurality of other communication apparatuses, with the other communication apparatuses.

12. A communication terminal comprising
a communication control unit that sets a first secret key to be used for decryption on a basis of identification information indicating a communication apparatus that performs coordinated transmission together using the first secret key for the coordinated transmission and groupcast when a signal is received by the coordinated transmission by a plurality of communication apparatuses.

13. The communication terminal according to claim 12,
wherein the communication control unit acquires the first secret key simultaneously with a second secret key for groupcast notified from the communication apparatus.

14. The communication terminal according to claim 12, further comprising
a storage unit that stores the identification information together with the first secret key.

15. A communication method in which
a communication terminal is configured to
set a first secret key to be used for decryption on a basis of identification information indicating a communication apparatus that performs coordinated transmission together using the first secret key for the coordinated transmission and groupcast when a signal is received by the coordinated transmission by a plurality of communication apparatuses.
